(19) United States
(12) Patent Application Publication
(10) Pub. No.: US 2006/0216999 A1
(43) Pub. Date: Sep. 28, 2006

(54) 5-In-1 connector for memory cards

(75) Inventor: Wen-Hsiang Hsiao, Taipei City (TW)

Correspondence Address: BACON & THOMAS, PLLC, 625 SLATERS LANE, FOURTH FLOOR, ALEXANDRIA, VA, 22314, US

(73) Assignee: WEM TECHNOLOGY INC., Taipei City (TW)

(21) Appl. No.: 11/090,280

(22) Filed: Mar. 28, 2005

(51) Int. Cl. H01R 24/00

(52) U.S. Cl. 439/630

(57) ABSTRACT

A 5-in-1 connector for memory cards having a slot on a main body of the connector for insertion of any of an SD, an MMC 4.0, an MMC, an RS-MMC and a mini SD memory card, the slot is provided at its middle section with a first pin set for electric connection with connecting pins of any of an SD, an MMC 4.0, an MMC and an RS-MMC memory card; and is provided at a deep area in its rear section with a second pin set for electric connection with connecting pins of a mini SD memory card; further is provided at its front section with a third pin set for electric connection with data connecting pins of the MMC 4.0 memory card. The first to third pin sets are located individually beneath the bottom of the slot, so that all the memory cards are identically inserted with their pins facing downwards.

### BACKGROUND OF THE INVENTION

1. Field of the Invention

The present invention is related to an improved connector for memory cards, and especially to a 5-in-1 connector to make connection of power and transmitting data from pins of memory cards of the specifications including an SD memory card (Secure Digital Card), an MMC 4.0 (MultiMedia Card 4.0), an MMC (MultiMedia Card), an RS-MMC memory card (Reduced Size MultiMedia Card) and a mini SD (mini-Secure Digital Card) etc. with an electric device.

2. Description of the Prior Art

In the recent years, storing carriers of the type of memory cards (or called as flash memory cards) has superior features of being light, thin and small, having high storing capabilities, vibration durability and repeated memorizing for many times etc., thereby they are widely applied on household electric appliances of information, personal computers or portable digital products (hereinafter unitarily called as electric devices).

Normal electric devices using memory cards as storing carriers basically still take memory cards of specific types as data storing carriers, the most popular memory card types include CFs (CompactFlash cards), SMs (Smart Media Cards), MSs (Memory Stick Cards), SDs (Secure Digital Cards), MMCs (MultiMedia Cards), RS-MMCs (Reduced-Size MultiMedia Cards) etc., and even there are mini SDs (mini-Secure Digital Cards) in the markets specific for cell phones and TFs (TransFlash cards).

However, the memory cards of various specifications seen in the markets presently have the states that the memory cards are unable to get effective communication between a portable digital product and an electric device such as a computer system, a periphery device of the computer system etc.; and even a limitation in purchasing of the customers may be resulted. Thereby, some memory card manufacturers have developed memory cards compatible with the specifications of existing memory cards but having slightly smaller sizes in order to suit portable digital electric devices with smaller sizes.

For example, an SD and an MMC are memory cards identical in contour and size, while the chip and electric specification (protocol) of an RS-MMC is identical to those of an MMC memory card except the size is slightly smaller than the latter; similarly, the chip and electric specification of an MMC memory card is identical to those of an SD memory card except the size is slightly smaller than the latter.

Particularly, for the purpose of making improvement of transmitting speeds for the devices such as cell phones, DSCs, DVCs etc. with larger requirements of capacities, MMC 4.0 memory cards seen in the markets recently have been improved in transmitting speed upon the MMC memory cards, in which 9 pins are changed to 13 pins. In comparing with the mode of transmitting data with 4 bits for MMC and SD memory cards, the MMC 4.0 memory cards transmit data with 8 bits. In other words, the four added pins of an MMC 4.0 memory card can provide more transmitting channels for data, thus the transmitting speed can be increased; they can meet the requirements of transmitting of electric devices with larger capacities, and can be compatible with the specifications of existing memory cards.

By virtue that the contour of each of an MMC 4.0 memory card, an RS-MMC memory card and a mini SD memory card is slightly different from either of an MMC memory card and an SD memory card, for the existed techniques presently, there has been a connector simultaneously common to four types of memory cards including an SD, an MMC, an RS-MMC and a mini SD memory card; however, there has not yet been a connector suitable for inserting therein an MMC 4.0 memory card. In view of this, application of an MMC 4.0 memory card on electric devices with existing specifications in real situations still has its limitation.

Moreover, a connector common to multiple types of memory cards itself not only must be provided with insertion slots (or related positioning structures) to surely correspondingly position memory cards (or the related positioning structures), but also especially be provided with good devices for pin arrangements in order to surely make circuit connecting of the corresponding memory cards with an electric device.

Various connectors each common to multiple types of memory cards in the markets make insertion of memory cards into a connector mostly to be in different orientations because of the problem of limitation in devices for pin arrangements; that is, some memory cards insert in normal ways with their pins facing downwards, and some memory cards insert in contrary ways with their pins facing upwards. In this case, consumers are subjected to being confused, they shall again and again make sure whether the ways of insertion are correct, and this is quite inconvenient in use.

### SUMMARY OF THE INVENTION

In view of these, the 5-in-1 connector for memory cards of the present invention has a slot on a main body of the connector for insertion of any of an SD, an MMC 4.0, an MMC, an RS-MMC and a mini SD memory card. The slot is provided at its middle section with a first pin set for electric connection with connecting pins of any of an SD, an MMC 4.0, an MMC and an RS-MMC memory card; and is provided at a deep area in its rear section with a second pin set for electric connection with connecting pins of a mini SD memory card; further is provided at its front section with a third pin set for electric connection with data connecting pins of the MMC 4.0 memory card.

The object of the present invention is, in addition to have a slot on a main body of the connector for insertion of any of five kinds of memory cards with different specifications, to have the above stated three (the first to the third) pin sets located individually beneath the bottom of the slot, so that the memory cards are identically inserted with their pins facing downwards, thus users will not be confused, and an effect of convenience of use can be obtained.

The present invention will be apparent in its structural combination and the entire mode of operation thereof after reading the detailed description of the preferred embodiment thereof in reference to the accompanying drawings.

### BRIEF DESCRIPTION OF THE DRAWINGS

FIG. 1 is a schematic perspective view showing the appearance of the 5-in-1 connector of the present invention;

FIG. 2 is a top view schematically showing the allocation of pins of the present invention;

FIG. 3 is a bottom view schematically showing the allocation of pins of the present invention;

FIG. 4 is a front view schematically showing the allocation of pins of the present invention;

FIG. 5 is a rear view schematically showing the allocation of pins of the present invention.

### DETAILED DESCRIPTION OF THE PREFERRED EMBODIMENT

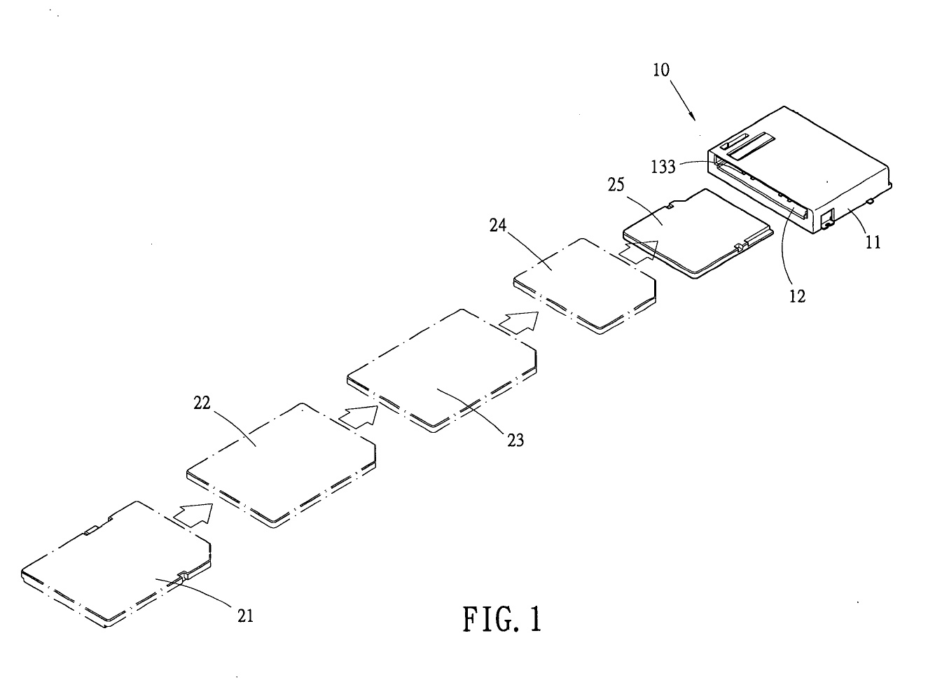

The basic structure combination of the 5-in-1 connector for memory cards of the present invention is as shown in FIG. 1, wherein the connector 10 has a main body 11 in the form of a cartridge; the main body 11 has thereon a slot 12 for insertion and positioning of any of the five memory cards including an SD memory card 21, an MMC 4.0 memory card 22, an MMC memory card 23, an RS-MMC memory card 24 and a mini SD memory card 25.

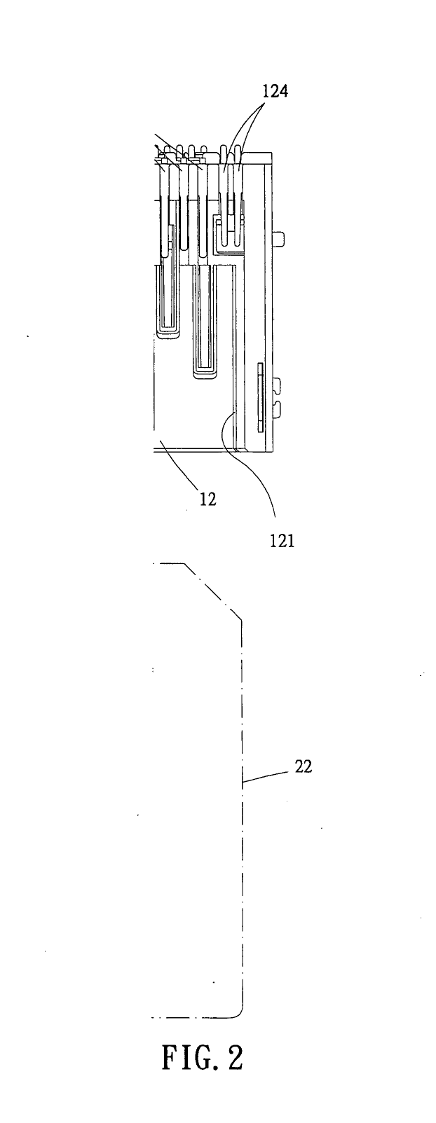

The slot 12 is arranged therein with a plurality of pin sets, the pin sets are extended toward the slot 12 from the rear side of the main body 11 (further please refer to FIG. 2); when any of the above list memory cards is inserted into the slot 12, the pin sets can directly make electric connection with the pins of a corresponding memory card, thereby any of the memory cards can make circuit connection with an electric device via the connector of the present invention.

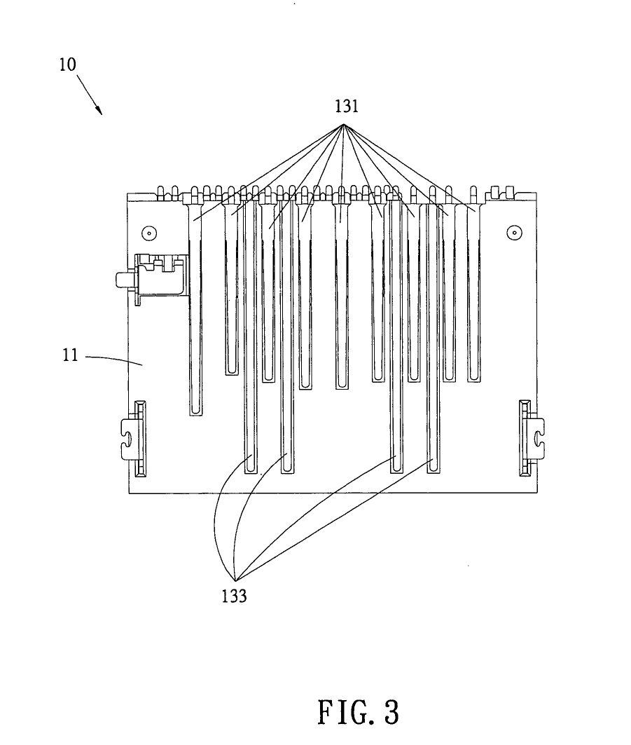

Referring simultaneously to FIG. 2 which is a top view schematically showing the allocation of pins on the main body 11 of the connector 10 and to FIG. 3 which is a bottom view schematically showing the allocation of pins on the main body 11 of the connector 10, in the drawings shown, the slot 12 extends rearwards from the front side of the main body 11 (the lower area in the drawing is the front side of the main body 11), and the slot 12 is provided at its middle section on the rear side thereof with a first pin set 131 for electric connection with connecting pins of any of an SD, an MMC 4.0, an MMC and an RS-MMC memory card.

The slot 12 on the main body 11 of the connector 10 is provided at the rear section thereof with a second pin set 132 for electric connection with connecting pins of a mini SD memory card. Further the slot 12 is provided at its front section with a third pin set 133 for electric connection with data connecting pins of the MMC 4.0 memory card.

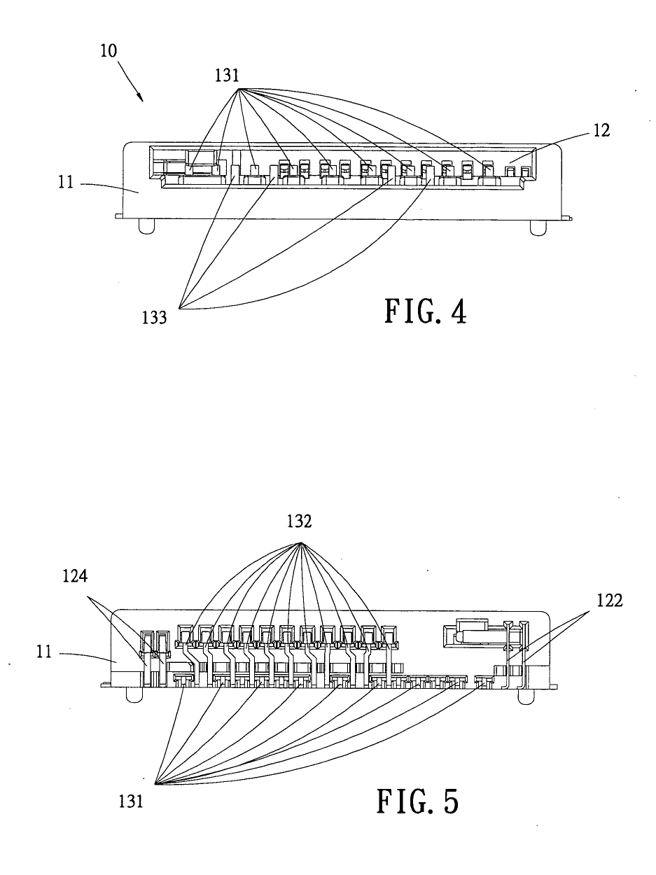

As shown in FIGS. 4 and 5 which are respectively a front view and a rear view schematically showing the allocation of pins on the main body 11 of the present invention, by the fact that the 5-in-1 connector of the present invention is provided mainly for electric connection with connecting pins of any of an SD, an MMC 4.0, an MMC, an RS-MMC memory card and a mini SD memory card, to provide all the above mentioned first, second and third pin sets 131, 132 and 133 on the bottom surface of the slot 12, the SD, MMC 4.0, MMC, RS-MMC and mini SD memory cards can be inserted identically with their pins facing downwards, thus confusion can be avoided, and convenience of use can be increased. Certainly, if the pin sets 131, 132 and 133 are all provided on the top surface of the slot 12, the memory cars can be inserted identically with their pins facing upwards, another embodiment with the same efficiency can be obtained, and it is not necessary to be further described.

As shown in FIGS. 2 and 3, in practicing the present invention, the entire connector 10 is further provided in the slot 12 with a first positioning area 121 for positioning an SD, an MMC 4.0, an MMC or an RS-MMC memory card, and a first sensing piece 122 for sensing whether the SD, MMC 4.0, MMC or RS-MMC memory card is in position after insertion; certainly, a second positioning area 123 for positioning a mini SD memory card and a second sensing piece 124 for sensing whether the mini SD memory card is in position after insertion can be provided.

Therefore, the 5-in-1 connector for memory cards of the present invention can be provided for making connection of power and transmitting data from pins of any of the memory cards of the specifications including an SD, an MMC 4.0, an MMC, an RS-MMC and a mini SD memory card etc. with an electric device; it can largely increase the applicability as well as convenience of connection of the electric device with the storing carrier including the SD, MMC 4.0, MMC, RS-MMC or mini SD memory card, and thereby the added function of the entire electric device can be elevated.

Accordingly, the above description and drawings are only for illustrating a preferred embodiment of the present invention, and not for giving any limitation to the scope of the present invention. It will be apparent to those skilled in this art that various equivalent modifications or changes without departing from the spirit, scope and characteristic of this invention shall also fall within the scope of the appended claims of the present invention.

1. A 5-in-1 connector for memory cards, comprising a main body having a slot defined therein for insertion of any of five memory cards including an SD, an MMC 4.0, an MMC, an RS-MMC and a mini SD memory card;
wherein said slot is provided on a bottom surface thereof with a first, a second and a third pin set, wherein said first pin set is located at a middle section of said slot for electric connection with connecting pins of any of said SD, said MMC 4.0, said MMC and said RS-MMC memory cards, said second pin set is located at a rear section of said slot for electric connection with connecting pins of said mini SD memory card, said third pin set is located at a front section of said slot for electric connection with data connecting pins of said MMC 4.0 memory card;
wherein said slot is further provided with a first positioning area for positioning an SD, an MMC 4.0, an MMC or an RS-MMC memory card, and with a first sensing piece for sensing whether said SD, MMC 4.0, MMC or RS-MMC memory card is in position after insertion; and
wherein said slot is further provided with a second positioning area for positioning a mini SD memory card during inserting and a second sensing piece for sensing whether said mini SD memory card is in position after insertion.

2. The 5-in-1 connector for memory cards as in claim 1, wherein said first, second and third pin sets are extended toward said slot from a rear side of said main body.

3. (canceled)

4. (canceled)
